(19) United States
(12) Patent Application Publication
(10) Pub. No.: US 2024/0002240 A1
(43) Pub. Date: Jan. 4, 2024

(54) BORON-CONTAINING SILICA DISPERSION, AND METHOD FOR PRODUCING SAME

(71) Applicant: SAKAI CHEMICAL INDUSTRY CO., LTD., Sakai-shi, Osaka (JP)

(72) Inventors: Yasuyuki MURAKAMI, Osaka (JP); Satsuki MOTOISHI, Osaka (JP); Hisao KOIZUMI, Osaka (JP); Satoshi KOMORI, Fukushima (JP); Hironobu OGATA, Fukushima (JP)

(21) Appl. No.: 18/247,010

(22) PCT Filed: Sep. 21, 2021
(86) PCT No.: PCT/JP2021/034573

§ 371 Date: Mar. 28, 2023

(30) Foreign Application Priority Data
Oct. 1, 2020 (JP) 2020-167311

(51) Int. Cl. C01B 33/141

(52) U.S. Cl. CPC C01B 33/1415; C01P 2004/51; C01P 2002/01; C01P 2004/32; C01P 2004/64

(57) ABSTRACT

The present invention provides a boron-containing silica dispersion having better dispersion stability at a high concentration, and higher binding properties between boron and silica than conventional dispersions. The present invention is a boron-containing silica dispersion containing amorphous silica particles containing boron atoms and a dispersion medium; the boron-containing amorphous silica particles having an average particle size of 10 to 100 nm, as determined from 40 particles selected at random in a transmission electron micrograph; the boron-containing silica dispersion having a solids content of 5 to 30 mass %; and the boron-containing silica dispersion having a sedimentation rate of the particles of 4% or less, when the boron-containing silica dispersion is left standing for 1000 hours, and proportions of SiO₂ and B₂O₃ of 90.0 to 99.8 mass % and 0.2 to 10.0 mass %, respectively, in 100 mass % of a total of SiO₂ and B₂O₃, all terms of oxide, when the boron-containing silica dispersion is subjected to ultrafiltration by the following method and dried; <Ultrafiltration method> washing is performed by sequentially adding pure water in an amount of 6 times the volume of the boron-containing silica dispersion at a flow rate of a liquid fed of 3660 ml/minute using an ultrafiltration membrane with a fraction molecular weight of 13,000.

### TECHNICAL FIELD

The present invention relates to a boron-containing silica dispersion and a method for producing the same. More specifically, it relates to a boron-containing silica dispersion that can be suitably used as a sintering aid for ceramic materials such as multilayer ceramic capacitors and a method for producing the same.

### BACKGROUND ART

When silica particles are mixing with resins, resin raw materials, or the like, the properties such as the strength, hardness, heat resistance, insulating properties can be improved, and accordingly, silica particles are suitably used for applications such as adhesive materials, dental materials, optical members, coating materials, and nanocomposite materials. Further, silica particles having a minute particle size are also used as a polishing agent for silicon wafers or the like because of their hardness.

Since silica particles tend to agglomerate, techniques for improving the dispersion stability of silica particles have been developed conventionally (see Patent Literatures 1 to 4).

Silica-based glasses are used as materials (sintering aids) that decrease the sintering temperature when mixed with ceramics, for example, in the production of low-temperature co-fired substrates.

With the size reduction of electronic parts such as multilayer ceramic capacitors (MLCCs), ceramic powders for forming various porcelains constituting them have been made finer. For producing the MLCCs, glass powders to be added as sintering aids to adjust the sintering characteristics of dielectric layers have also been made finer.

As such a sintering aid, a technique involving use of a low-melting-point glass, for example, has been developed, but it has not been sufficient for high-frequency material applications due to its low Q value.

Patent Literature 5, for example, also discloses spherical glass fine particles having a composition free from Al₂O₃ and containing 40 to 97 mol of SiO₂, 50 mol % or less of one or more alkali earth metal oxides selected from the group consisting of MgO, CaO, SrO, and BaO, or further 60 mol % or less of one or more metal oxides selected from the group consisting of Li₂O, Na₂O, and K₂O, all in terms of oxide, and having an average particle size of 20 nm or more and less than 1000 nm.

In order to uniformly mix minute dielectric powder with a minute sintering aid, and further decrease the firing temperature, a boron-doped silica dispersion is used as the sintering aid. For example, Patent Literature 6 discloses spherical glass fine particles having a composition containing 40 to 95 mol % of SiO₂, 0.5 to 40 mol % of B₂O₃, and 0.5 to 40 mol % of ZnO, in terms of oxide, and having an average particle size of 20 nm or more and less than 1000 nm. Patent Literature 7 discloses glass sol containing a solvent and glass powder dispersed therein, in which the glass powder contains silicon oxide and boron oxide and has a 50% percentile of the particle size, D50, of 30 to 100 nm in the number-based particle size distribution and a coefficient of variation of the particle size (standard deviation/average particle size) of 50% or less.

### CITATION LIST

Patent Literature
Patent Literature 1: JP 2003-176123 A
Patent Literature 2: JP 2005-231954 A
Patent Literature 3: JP 2019-182688 A
Patent Literature 4: JP 2017-117847 A
Patent Literature 5: JP 2010-254574 A
Patent Literature 6: JP 2011-068507 A
Patent Literature 7: JP 2008-184351 A

### SUMMARY OF INVENTION

Technical Problem

As described above, various boron-doped silica dispersions have been conventionally developed; however, conventional boron-doped silica dispersions do not have sufficient binding properties between boron and silica, and thus a problem thereof is that the boron content in the boron-doped silica dispersion is reduced since the boron component, which tends to be liberated, is removed when the boron-doped silica dispersion is concentrated by ultrafiltration in order to improve the handleability when mixing with dielectric powder or the like. Further, conventional boron-doped silica dispersions have insufficient dispersion stability when the concentration of silica particles is high.

The present invention has been made under the above-described circumstances, and an object thereof is to provide a boron-containing silica dispersion, having better dispersion stability at a high concentration and higher binding properties between boron and silica than conventional dispersions.
Solution to Problem

As a result of various studies on boron-containing silica dispersions, the inventors have found that a boron-containing silica dispersion having: a solids content of 5 to 30 mass % after ultrafiltration by a predetermined method; a sedimentation rate of the particles of 4% or less, when the boron-containing silica dispersion is left standing for 1000 hours; and a proportion of B₂O₃ of 0.2 to 10.0 mass % in 100 mass % of a total of SiO₂ and B₂O₃, all in terms of oxide, when subjected to ultrafiltration and dried has higher concentration, better dispersion stability, and higher binding properties between boron and silica than conventional boron-containing silica dispersions, and can thus solve the aforementioned problems surprisingly, thereby achieving the present invention.

Specifically, the present invention is a boron-containing silica dispersion containing amorphous silica particles containing boron atoms and a dispersion medium; the boron-containing amorphous silica particles having an average particle size of 10 to 100 nm, as determined from 40 particles selected at random in a transmission electron micrograph; the boron-containing silica dispersion having a solids content of 5 to 30 mass %; the boron-containing silica dispersion having a sedimentation rate of the particles of 4% or less, when the boron-containing silica dispersion is left standing for 1000 hours, and proportions of SiO₂ and B₂O₃ of 90.0 to 99.8 mass % and 0.2 to 10.0 mass %, respectively, in 100 mass % of a total of SiO₂ and B₂O₃, all in terms of oxide, when the boron-containing silica dispersion is subjected to ultrafiltration by the following method and dried:

### <Ultrafiltration Method>

Washing is performed by sequentially adding pure water in an amount of 6 times the volume of the boron-containing silica dispersion at a flow rate of a liquid fed of 3660 ml/minute using an ultrafiltration membrane with a fraction molecular weight of 13,000.

The boron-containing amorphous silica particles preferably have an average particle size D₅₀ of 10 to 100 nm in the particle size distribution thereof, as determined by the following method:

### <Determination Method of Particle Size Distribution>

the volume-based average particle size is measured using a dynamic light scattering particle size distribution analyzer;
a slurry containing the boron-containing amorphous silica particles is diluted with ion-exchanged water so that the particle concentration at the time of measurement is suitable for measurement (in the range of loading index=0.01 to 1);
measurement time is 60 seconds;
permeability of particle: permeable, refractive index of particle: 1.46, shape: perfect sphere, density (g/cm³): 1.00, solvent: water, refractive index: 1.333, viscosity at 30° C.: 0.797, and viscosity at 20° C.: 1.002; and
the 50th percentile of the particle size in the volume-based particle size distribution curve obtained is defined as the average particle size D₅₀ (nm).

The boron-containing silica dispersion preferably has a coefficient of variation of the particle size, standard deviation of particle size/average particle size, of 0.25 or less, as determined from 40 particles selected at random in a transmission electron micrograph.

The boron-containing silica dispersion preferably has D₉₀/D₁₀ of 4.0 or less and D₁₀₀ of 300 nm or less in the particle size distribution.

The boron-containing amorphous silica particles preferably have an average circularity of 0.65 or more, as determined by the following method:

### <Determination Method of Average Circularity>

a file of a TEM image captured under a transmission electron microscope is read by an image analysis software, and the average circularity of 40 particles is determined by running an application for a particle analysis.

A dried product of the boron-containing silica dispersion preferably has a decrement in the boron content of 10 mass % or less, when the dried product is fired under the following conditions:

### <Firing Conditions>

5 to 10 g of the dried product is filled into an alumina crucible, heated to 1000° C. to 1100° C. at 200° C./hour in the atmosphere, maintained as it is for 5 hours, and cooled to room temperature.

The boron-containing silica dispersion preferably has a viscosity of 15 mPa·s or less, as measured by the following method:

### <Measurement Method of Viscosity>

the viscosity of the boron-containing silica dispersion is measured at a temperature of 25° C. using a vibration viscometer.

The present invention is also a method for producing the boron-containing silica dispersion, the method including: step (A) of obtaining seed particles containing silicon atoms; and step (B) of mixing the seed particles containing silicon atoms obtained in step (A), a silicon atom-containing compound different from the seed particles obtained in step (A), and a boron atom-containing compound.

The amount of the boron atom-containing compound used is preferably 0.4 to 10 mol %, in terms of the number of boron atoms, based on 100 mol % of a total of silicon atoms in the seed particles containing silicon atoms and the silicon atom-containing compound different from the seed particles.

The amount of the seed particles containing silicon atoms used is preferably 1 to 20 mol %, in terms of the number of silicon atoms, based on 100 mol % of a total of silicon atoms in the seed particles containing silicon atoms and the silicon atom-containing compound different from the seed particles.

In the mixing step (B), a basic catalyst is preferably added in amount of 10 to 50 mol % based on 100 mol % of a total of silicon atoms in the silicon atom-containing compound different from the seed particles and boron atoms in the boron atom-containing compound.
Advantageous Effects of Invention

The boron-containing silica dispersion of the present invention, which has the aforementioned configurations, has high concentration, excellent dispersion stability, and high binding properties between boron and silica, and accordingly, it can be suitably used as a sintering aid or the like for ceramic materials such as multilayer ceramic capacitors.

### BRIEF DESCRIPTION OF DRAWINGS

FIG. 1 is a TEM image (magnification: 50,000×) of a silica dispersion 1 obtained in Example 1.

FIG. 2 is a TEM image (magnification: 100,000×) of a silica dispersion 3 obtained in Example 3.

FIG. 3 is a TEM image (magnification: 50,000×) of a comparative silica dispersion 1 obtained in Comparative Example 1.

FIG. 4 is a TEM image (magnification: 30,000×) of a comparative silica dispersion 2 obtained in Comparative Example 2.

FIG. 5 is a TEM image (magnification: 5,000×) of a comparative silica dispersion 3 obtained in Comparative Example 3.

FIG. 6 is a TEM image (magnification: 50,000×) of a comparative silica dispersion 4 obtained in Comparative Example 4.

FIG. 7 shows the results of TG analysis for a dry powder 1 obtained in Example 1 and comparative dry powders 1 and 2 obtained in Comparative Examples 1 and 2.

FIG. 8 shows the results of DTA analysis for the dry powder 1 obtained in Example 1 and the comparative dry powders 1 and 2 obtained in Comparative Examples 1 and 2.

FIG. 9 shows the evaluation results of the HALT test for MLCCs using the dry powder 1 obtained in Example 1 and the comparative dry powder 1 obtained in Comparative Example 1.

### DESCRIPTION OF EMBODIMENTS

Hereinafter, preferable embodiments of the present invention will be specifically described, but the present invention is not limited only to the following descriptions and can be appropriately modified without departing the spirit of the present invention. An embodiment in which two or more of the preferable embodiments of the present invention described below are combined is also a preferable embodiment of the present invention.

### <Boron-Containing Silica Dispersion>

The boron-containing silica dispersion of the present invention contains amorphous silica particles containing boron atoms and a dispersion medium, and has a solids content, of 5 to 30 mass %, after ultrafiltration by the aforementioned method, and a sedimentation rate of 4% or less, when the dispersion is left standing for 1000 hours. Accordingly, the dispersion stability is excellent even at a high concentration, leading to excellent handleability when mixed with dielectric powder or the like.

The solids content after ultrafiltration is preferably 10 to 25 mass %, more preferably 12 to 20 mass %, further preferably 15 to 18 mass %.

The sedimentation rate of the particles when left standing for 1000 hours is preferably 3% or less, more preferably 2% or less, further preferably 1% or less. The sedimentation rate can be determined by the method described in EXAMPLES.

The proportions of SiO₂ and B₂O₃ are 90.0 to 99.8 mass % and 0.2 to 10.0 mass %, respectively, in 100 mass % of a total of SiO₂ and B₂O₃, all in terms of oxide, when the boron-containing silica dispersion is subjected to ultrafiltration by the aforementioned method and dried. If binding of boron is not firm in silica particles, the proportion of B₂O₃ after ultrafiltration is reduced; however, the boron-containing silica dispersion of the present invention can maintain the proportion of B₂O₃ in the aforementioned range even after ultrafiltration by the aforementioned method.

The proportion of B₂O₃ is preferably 0.9 to 7.0 mass %, more preferably 1.7 to 5.2 mass %, further preferably 2.6 to 4.5 mass %.

The proportion of SiO₂ is preferably 93.0 to 99.1 mass %, more preferably 94.8 to 98.3 mass %, further preferably 95.5 to 97.4 mass %.

The aforementioned proportions of SiO₂ and B₂O₃ each can be determined by the method described in EXAMPLES.

The proportions of SiO₂ and B₂O₃ in terms of oxide are fall within the aforementioned ranges when the boron-containing silica dispersion is subjected to ultrafiltration by the aforementioned method and dried, and on the other hand, the proportions of SiO₂ and B₂O₃ in terms of oxide before ultrafiltration are preferably 90.0 to 99.8 mass % and 0.2 to 10.0 mass %, respectively, in 100 mass % of a total of SiO₂ and B₂O₃. When the proportion of B₂O₃ is 10.0 mass % or less, the durability of an electronic device is further improved when the boron-containing silica dispersion is used as a material of electronic parts thereof such as multilayer ceramic capacitors (MLCCs).

The boron-containing amorphous silica particles have an average particle size (hereinafter also referred to as TEM average particle size) of 10 to 100 nm, as determined from 40 particles selected at random in a transmission electron micrograph.

The TEM average particle size is a primary particle size. When the primary particle size is 100 nm or less, the particle size is equal to or smaller than that of ceramic powders such as submicron dielectric powders used, for example, for multilayer ceramic capacitors, and accordingly, the particles can be dispersed when mixed with such ceramic powder so as to be easily fitted in the grain boundaries of the ceramic powder, to form a more uniform and thinner grain boundary phase between particles of the ceramic powder.

The TEM average particle size is preferably 15 to 75 nm, more preferably 20 to 50 nm, further preferably 25 to 30 nm.

The boron-containing amorphous silica particles preferably have an average particle size D₅₀ of 10 to 100 nm in the particle size distribution thereof, as determined by the aforementioned method. The average particle size D₅₀ is more preferably 15 to 75 nm, further preferably 20 to 50 nm, particularly preferably 25 to 30 nm.

The boron-containing silica dispersion preferably has a coefficient of variation of the particle size, standard deviation of particle size/average particle size, of 0.25 or less, as determined from 40 particles selected at random in a transmission electron micrograph.

The boron-containing silica dispersion preferably has D₉₀/D₁₀ of 4.0 or less in the aforementioned particle size distribution. The D₁₀ means a 10th percentile of the particle size on a volume basis, and the D₉₀ means a 90th percentile of the particle size on a volume basis.

D₉₀/D₁₀ is an index of the sharpness of the volume-based particle size distribution. As the value of D₉₀/D₁₀ increases, the particle size distribution is broader, and as the value decreases, the particle size distribution is sharper. When D₉₀/D₁₀ is 4.0 or less, the variation in particle size is sufficiently suppressed from excessively increasing. Owing to this, the particles can be dispersed more uniformly in other materials, and also, poor fluidity and formability when mixed with other materials such as dielectric powder is sufficiently suppressed.

The boron-containing silica dispersion preferably has a D₁₀₀ of 300 nm or less. It is more preferably 200 nm or less, further preferably 100 nm or less.

An embodiment of the boron-containing silica dispersion in which D₉₀/D₁₀ is 4.0 or less with a D₁₀₀ of 300 nm or less in the particle size distribution is one of preferable embodiments of the present invention.

The boron-containing amorphous silica particles in the boron-containing silica dispersion preferably have an average circularity of 0.65 or more, as determined by the aforementioned method. This allows the particles to be dispersed more uniformly in other materials, and also sufficiently suppressed poor fluidity and formability when mixed with other materials such as dielectric powder. Further, this enables suppression of the wear of the molding die when molding the resin.

A dried product of the boron-containing silica dispersion preferably has a decrement in the boron content of 10 mass % or less, when the dried product of the dispersion is fired under the aforementioned conditions. Since the boron-containing silica dispersion of the present invention has high binding properties between boron and silica, a decrease in the boron content due to firing can be suppressed.

The decrement in boron content is more preferably 9.5 mass % or less, further preferably 9 mass % or less.

The decrement in boron content can be determined by the method described in EXAMPLES.

The boron-containing silica dispersion preferably has a viscosity of 15 mPa·s or less, as measured by the aforementioned method. This results in excellent handleability of the boron-containing silica dispersion of the present invention.

The viscosity is more preferably 10 mPa·s or less, further preferably 5 mPa·s or less. Further, the viscosity is preferably 0.01 mPa·s or more.

The boron-containing silica dispersion of the present invention preferably includes a solvent. The solvent is not limited, and examples thereof include water, methanol, ethanol, dimethylacetamide, ethylene glycol, and 2-methoxy-1-methylethyl acetate. Among them, water is preferable.

The boron-containing silica dispersion of the present invention may contain other components in addition to the boron-containing amorphous silica particles and the solvent. The other components are not limited, and examples thereof include the unreacted raw materials of the boron-containing silica dispersion, ammonia, ethylenediamine, diethylenetriamine, triethylenetetraamine, urea, ethanolamine, and tetramethyl ammonium hydroxide.

The content of the other components is not limited but is preferably 0 to 10 mass % based on 100 mol % of the boron-containing silica dispersion. It is more preferably 0 to 5 mass %, further preferably 0 to 1 mass %, most preferably 0 mass %.

### <Method for Producing Boron-Containing Silica Dispersion>

The method for producing the boron-containing silica dispersion of the present invention is not limited, and it can be produced by a step of obtaining seed particles containing silicon atoms, and a step of mixing the seed particles obtained, a silicon atom-containing compound different from the seed particles, and a boron atom-containing compound.

The present invention is also a method for producing a boron-containing silica dispersion, the method including step (A) of obtaining seed particles containing silicon atoms, and step (B) of mixing the seed particles containing silicon atoms obtained in step (A), a silicon atom-containing compound different from the seed particles obtained in step (A), and a boron atom-containing compound.

In step (B), use of the seed particles containing silicon atoms enables the silica particles to be uniformly doped with boron.

The “silicon atom-containing compound different from the seed particles” used in step (B) may have the same composition of the compound as that of the seed particles, as long as it is a material other than the seed particles obtained in step (A).

In the method for producing a boron-containing silica dispersion, boron that has deposited from the boron atom-containing compound is preferably reacted with a hydrolysate of the silicon atom-containing compound for production. Since the hydrolysis rate of the silicon atom-containing compound is lower than the deposition rate of boron, they usually deposit as separate particles. However, it is considered that when the seed particles containing silicon atoms is used, the seed particles serves as reaction fields, and that the silicon atom-containing compound different from the seed particles is hydrolyzed to allow the particles to grow while involving boron, whereby the particles can be uniformly doped with boron.

Step (A) is not limited as long as the seed particles containing silicon atoms are obtained, but step (A) is preferably a step of decomposing the silicon-containing compound.

The silicon-containing compound used in step (A) is not limited but is preferably silicon alkoxide or the like.

In the case of using silicon alkoxide in step (A), the silicon alkoxide is hydrolyzed to generate silicon dioxide, orthosilicic acid, metasilicic acid, metadisilicic acid, or the like, as the seed particles.

The average particle size of the seed particles containing silicon atoms is not limited, but the average particle size is preferably 5 to 15 nm, more preferably 10 to 13 nm, as determined from 40 particles in a transmission electron micrograph. Also, the average particle size D₅₀ in the particle size distribution measured by the aforementioned method is preferably 1 to 15 nm, more preferably 5 to 10 nm.

In the case where the seed particles containing silicon atoms are silicon dioxide, it is preferable one obtained by hydrolyzing silicon alkoxide (hydrolysate of silicon alkoxide).

Preferable examples of the silicon alkoxide include methyl silicates such as tetramethoxysilane; ethyl silicates such as tetraethoxysilane; and isopropyl silicates such as tetraisopropoxysilane. Among them, ethyl silicates are preferable, and tetraethoxysilane (TEOS) is more preferable.

The hydrolysate is preferably obtained by reacting the silicon alkoxide, water, and a catalyst.

The catalyst is preferably a basic catalyst, more preferably, basic amino acids such as arginine, lysine, histidine, and tryptophan, further preferably arginine.

Use of arginine enables smaller seed particles to be obtained.

In step (A), the amount of the catalyst used is not limited but is preferably 0.5 to 3 mol %, more preferably 1.5 to 2.5 mol %, based on 100 mol % of the silicon alkoxide.

In step (A), the reaction temperature is not limited but is preferably 40° C. to 70° C., more preferably 55° C. to 65° C. When it is 40° C. or more, an excessive decrease in particle size of the seed particles is sufficiently suppressed, and the seed particles having a required size can be thus obtained. When it is 70° C. or less, an excessive increase in particle sized of the seed particles is sufficiently suppressed, and volatilization of the raw materials can also be suppressed more sufficiently.

In step (A), the method for adding the raw materials is not limited, but the silicon alkoxide is preferably added to a mixture of water and the catalyst.

In step (B), the amount of the seed particles containing silicon atoms used is preferably 1 to 20 mol %, in terms of the number of silicon atoms, based on 100 mol % of a total of silicon atoms in the seed particles containing silicon atoms and the silicon atom-containing compound different from the seed particles. When the amount of the seed particles used is 1 mol % or more, an excessive increase in particle size of the particles to be finally obtained can be sufficiently suppressed. Further, when the amount of the seed particles used is 1 mol % or more, the growth rate of the seed particles relative to the hydrolysis rate of the silicon atom-containing compound different from the seed particles falls within a more suitable range, so that formation of new particles on other location than the seed particles can be suppressed, and a broad particle size distribution can be thus sufficiently suppressed.

When the amount used is 20 mol % or less, the silicon atom-containing compound different from the seed particles can be sufficiently hydrolyzed.

The amount of the seed particles used is more preferably 5 to 20 mol %, further preferably 10 to 15 mol %.

In step (B), the amount of the boron atom-containing compound used is preferably 0.4 to 10 mol %, in terms of the number of boron atoms, based on 100 mol % of a total of silicon atoms in the seed particles containing silicon atoms and the silicon atom-containing compound different from the seed particles. When the amount of the boron atom-containing compound used is 10 mol % or less, formation of borate, and agglomeration and sedimentation thereof can be sufficiently suppressed. Further, when the amount of the boron atom-containing compound used is 10 mol % or less, the remaining of the unreacted boron atom-containing compound can be sufficiently suppressed, and agglomeration of the unreacted boron atom-containing compound can also be sufficiently suppressed.

The amount of the boron atom-containing compound used is more preferably 2 to 8 mol %, further preferably 4 to 6 mol %.

In step (B), a basic catalyst is preferably used.

By doing so, the dispersibility in the reaction solution can be sufficiently enhanced by addition of a base to sufficiently decrease the viscosity, in addition to actions as a catalyst.

The basic catalyst is not limited, but examples thereof include the aforementioned basic amino acids, ethylenediamine, diethylenetriamine, triethylenetetramine, ammonia, urea, ethanolamine, and tetramethyl ammonium hydroxide. Only one type of the basic catalyst may be used, but two or more types are preferably used in combination.

The basic catalyst is preferably ammonia or a basic amino acid.

By using ammonia, particles having a shape closer to the spherical shape can be obtained. By using arginine, particles having a smaller particle size can be obtained.

An embodiment in which ammonia and arginine are used in combination as basic catalysts is one of the preferable embodiments of the present invention.

In step (B), the amount of the basic catalyst used is preferably 10 to 50 mol %, based on 100 mol % of a total of silicon atoms in the silicon atom-containing compound different from the seed particles and boron atoms in the boron atom-containing compound. When the amount of the basic catalyst used is 50 mol % or less, the growth reaction of the particles can be suppressed to such an extent that necking involving the surrounding particles does not occur, and accordingly, the particles do not become large particles, whereby sedimentation can be reduced.

The amount of the basic catalyst used is more preferably 20 to 40 mol %, further preferably 25 to 35 mol %.

In the case of using ammonia as a basic catalyst, the amount used is preferably 10 to 50 mol %, based on 100 mol % of a total of silicon atoms in the silicon atom-containing compound different from the seed particles and boron atoms in the boron atom-containing compound.

When the amount of ammonia used is 10 mol % or more, the dispersibility can be improved more to sufficiently suppress the sedimentation of the particles. When the amount of ammonia used is 50 mol % or less, generation of ammonium borate can be sufficiently suppressed, and agglomeration due to this can be sufficiently suppressed. When it is 50 mol % or less, the circularity can fall within a more suitable range. The amount of ammonia used is more preferably 20 to 40 mol %, further preferably 25 to 35 mol %.

In step (B), the silicon atom-containing compound different from the seed particles is not limited as long as it is different from the seed particles and contains silicon atoms, but it is preferably the aforementioned silicon alkoxide. It is more preferably an ethyl silicate, further preferably tetraethoxysilane (TEOS).

In step (B), the boron atom-containing compound is not limited as long as it contains boron atoms, and examples thereof include boron alkoxides; boron oxides; boron oxoacids such as metaboric acid and orthoboric acid; and ammonium borates and hydrates thereof. Among them, boron alkoxides; and ammonium borates and hydrates thereof are preferable.

Examples of the boron alkoxides preferably include methyl borates such as trimethoxyborane; ethyl borates such as triethyl borate; and isopropyl borates such as triisopropoxyborane. Among them, ethyl borates are preferable, and triethyl borate (TEOB) is more preferable.

In step (B), a solvent is preferably used. Examples of the solvent preferably include water, and alcohols having 1 to 3 carbon atoms such as methanol, ethanol, and isopropyl alcohol. It is more preferably a mixed solvent of water and the alcohol.

The alcohols are preferably ethanol.

In the case of using a mixed solvent of water and the alcohol as the solvent, the proportion of the alcohol is preferably 140 to 150 mass %, more preferably 143 to 147 mass %, to 100 mass % of water. When the amount of alcohols is too small or too large, the silicon atom-containing compound added is less compatible with the solution and is present in the solution in the form of an emulsion, to thereby fail to allow the reaction to proceed sequentially, though the reason for this is not clear. This causes necking of the particles each other or generation of new secondary particles.

In step (B), the method for adding the raw materials is not limited, but step (B) preferably includes substep (B1) of mixing a solvent, the seed particles, and a basic catalyst, and substep (B2) of adding a silicon atom-containing compound different from the seed particles and a boron atom-containing compound to the mixed solution obtained in substep (B1).

The temperature in substep (B1) is not limited but is preferably 20° C. to 30° C.

In substep (B1), stirring is preferably performed.

In substep (B2), the method for adding the silicon atom-containing compound and the boron atom-containing compound is not limited, and these may be separately added or may be mixed before addition. An embodiment in which they are mixed before addition is preferable.

In substep (B2), the silicon atom-containing compound and the boron atom-containing compound may be added at a time or sequentially but is preferably added sequentially.

In substep (B2), the silicon atom-containing compound and the boron atom-containing compound may be added as solids or a solution but are preferably added as a solution.

It is preferable to add a mixed solution of the silicon atom-containing compound and the boron atom-containing compound dropwise to the mixed solution obtained in substep (B1).

The dropping time is not limited, but it is preferably 2 to 4 hours, more preferably 2 hours.

In substep (B2), the temperature is not limited but is preferably 45° C. to 65° C. When it is 45° C. or more, the reaction proceeds more easily, and when it is 65° C. or less, volatilization of the raw materials can be sufficiently suppressed.

In substep (B2), stirring is preferably performed.

In the method for producing the boron-containing silica dispersion of the present invention, an aging step is preferably performed after step (B).

The aging temperature is not limited but is preferably 20° C. to 30° C.

The aging time is not limited but is preferably 12 to 16 hours.

In the method for producing the boron-containing silica dispersion of the present invention, a concentration step may be performed after step (B) or the aging step.

The concentration method in the concentration step is not limited, but ultrafiltration is preferably mentioned.

### <Sintering Aid for Ceramic Materials>

Since the boron-containing silica dispersion of the present invention contains boron and has excellent low-temperature sinterability, it can be suitably used as a sintering aid for ceramic materials such as multilayer ceramic capacitors.

The present invention is also a sintering aid containing the boron-containing silica dispersion of the present invention.

### EXAMPLES

Hereinafter, the present invention will be described further in detail by way of examples, but the present invention is not limited to these examples. The symbol “%” means “mass %”, unless otherwise noted.

1. Various Measurements were Performed as Follows

### (1) Average Particle Size in Particle Size Distribution

On the dispersion obtained in each of Examples and Comparative Examples, the particle size distribution was determined using a dynamic light scattering particle size distribution analyzer (Nanotrac WaveII UT151, manufactured by MicrotracBEL Corp.).

A slurry containing boron-containing amorphous silica particles was appropriately diluted with ion-exchanged water so that the particle concentration at the time of measurement was a suitable concentration (in the range of loading index=0.01 to 1). In the case where a sample contained solids sedimented, the sample bottle was immersed in an ultrasonic cleaner (ASU-10, manufactured by AS ONE CORPORATION) for ultrasonic treatment for 10 minutes, to prepare a suspension of the sample.

The measurement time was 60 seconds.

Permeability of particle: permeable, refractive index of particles: 1.46, shape: perfect sphere, density (g/cm³):1.00, solvent condition: water, refractive index:1.333, viscosity at 30° C.: 0.797, and viscosity at 20° C.: 1.002.

### (2) Particle Size Analysis by Microscopy

The synthetic slurry and the dispersion obtained in each of Examples and Comparative Examples were subjected to particle size analysis. Using a field emission scanning electron microscope (JSM-7000F, manufactured by JEOL Ltd.) or a transmission electron microscope (JSM-2100F, manufactured by JEOL Ltd.), the sample was captured at a magnification such that at least 50 or more particles were seen in an image. The file of the captured image was read by an image analysis software (Eizo-kun, manufactured by Asahi Kasei Engineering Corporation), and the particle sizes of 40 particles with clear contours were measured by running an application for a circular particle analysis.

(i) Observation with SEM

A drop of the solution was placed on a sample table with a micro spatula, followed by drying at 105° C. for 2 to 3 minutes. The sample obtained was coated for 60 seconds using a platinum coater (JFC-1600, manufactured by JEOL Ltd.).

The coated sample was observed under a field emission scanning electron microscope. The measurement conditions were as follows: Acceleration voltage: 15.00 kV and WD: 10 mm.
(ii) Observation with TEM

A microgrid without support films (manufactured by JEOL Ltd., drawing number standard: CV 200MESH) was used. The cells of the microgrid was immersed in a slurry to be analyzed, excess moisture adhering to the cells was removed, and the cells were completely dried with a hair dryer. The dried sample was observed under a transmission electron microscope.

### (3) Thermal Weight Loss Analysis

The silica dry powder obtained in each of Examples and Comparative Examples was subjected to weight loss analysis in the firing process using a thermal analyzer (Thermo plas EVO TG 8120, manufactured by Rigaku Corporation). The measurement conditions were as follows: reference: alumina, sample pan: platinum, sample weight: 10 mg, atmosphere: air, measurement temperature range: 25° C. to 1000° C., and heating rate: 10.0° C./min.

### (4) Elemental Analysis (Determination of Boron Content and Decrement)

The silica dry powder and the silica fired product (fired powder) obtained in each of Examples and Comparative Examples were subjected to elemental analysis by a contained element-scanning function, EZ scanning, of an X-ray fluorescence analyzer (model number: ZSX PrimusII, manufactured by Rigaku Corporation).

Specifically, each pressed sample was set on the measurement sample stage, and the following conditions were selected: measurement range: B-U, measurement size: 30 mm, sample mode: metal, measurement time: standard, and atmosphere: vacuum), to measure the content of Si and the content of B in the powder. The found values obtained were converted into the contents of oxides to obtain the contents of SiO₂ and B₂O₃. Based on the Si content and the B content in the powder, the content of B₂O₃ (parts by weight) was calculated based on 100 parts by weight of the sum of the converted amount of SiO₂ and the converted amount of B₂O₃ in the powder.

Since the fired powder alone cannot be molded by pressing, it was mixed with a PVA solution and granulated to facilitate pressure molding. Specifically, a 10 mass % PVA aqueous solution was added little by little, so that the amount of PVA would be 0.8 to 1.5 mass % based on the fired powder, and the resultant was mixed in a mortar until the whole was uniform. The mixed powder was dried at 110° C. for 1 hour and de-agglomerated in a mortar. It was passed through a sieve with a mesh size of about 150 μm to obtain a sample for XRF analysis of the fired powder.

The boron decrement was determined by the following formula.

Boron decrement (%)=(B₂O₃ content in silica dry powder−B₂O₃ content in silica fired product)/(B₂O₃ content in silica dry powder)×100

### (5) Viscosity

On the dispersion obtained, the viscosity was measured at a temperature of 25° C. using a vibration viscometer (SV-1H, manufactured by A&D Company, Limited). 18 mL of the dispersion was put into a 20 mL screw tube (model number No. 5 (white), manufactured by Maruemu Corporation, body height: 55 mm, outer diameter: 27 mm) to subject to the measurement.

### (6) Sedimentation Rate

18 mL of the dispersion obtained in each of Examples and Comparative Examples was weighed into a 20 mL screw tube, followed by standing at 24° C. to 26° C. for 1000 hours, and the height of the dispersion, a, and the height of the sediment, b, were measured, to calculate the sedimentation rate by the following formula (1).

b/a×100(%) (1)

### 2. Preparation of Silica Dispersion, Dry Powder, and Fired Product

### Example 1

### (i) Preparation of Seed Particles (Seeds)

Ion-exchanged water (5361.5 g) and L(+)-arginine (10.5 g, manufactured by Wako Pure Chemical Industries, Ltd.) were mixed and heated to 60° C. using a heater. After stirring at 150 rpm, an ethyl orthosilicate (628.0 g, manufactured by TAMA CHEMICALS CO., LTD.) was added thereto. 7 hours after the addition of ethyl orthosilicate, heating was stopped, and a seed slurry 1 was collected about 16 hours after heating was stopped. The seed slurry 1 obtained was transparent with no sediments.

### (ii) Preparation of Silica Dispersion

Ion-exchanged water (1368.5 g), an industrial alcohol preparation (Alcosol P-5, 1376.1 g, manufactured by AMAKASU CHEMICAL INDUSTRIES), and the seed slurry 1 (997.2 g) were mixed. Further, L(+)-arginine (1.33 g) and 25% ammonia water (81.0 g, manufactured by Taiseikakou Co., Ltd.) were added thereto, and the solution temperature was raised to 55° C. using a heater. The solution was stirred at 750 rpm, and a mixed solution containing ethyl orthosilicate (675.9 g) and triethyl borate (26.2 g, manufactured by Tokyo Chemical Industry Co., Ltd.) was added thereto over 240 minutes, followed by washing with water in an amount of 6 times the liquid volume at a flow rate of a liquid fed of 3660 ml/minute using an UF membrane module “Microza” type ACP-1013D, manufactured by Asahi Kasei Corporation (fraction molecular weight of the ultrafiltration membrane: 13,000), to thereby obtain a silica dispersion 1. The silica particles in the silica dispersion 1 obtained were amorphous.

(iii) Preparation of Silica Dry Powder

The silica dispersion 1 was transferred to an evaporating dish and dried overnight at 105° C. to remove moisture, thereby obtaining silica dry powder 1.

### (iv) Preparation of Silica Fired Product (Fired Powder)

20 g of the silica dry powder 1 de-agglomerated in a mortar was filled into an alumina crucible, heated to 1100° C. at 200° C./hour in the atmosphere, maintained for 5 hours as it was, and then cooled to room temperature. The fired product thus obtained was de-agglomerated in a mortar, to obtain a silica fired product 1. The silica fired product 1 obtained was amorphous. Further, the silica dry powder 1 and the silica fired product (fired powder) 1 were subjected to elemental analysis, and as a result, the boron decrement was 8.3%.

### Example 2

### (i) Preparation of Seed Particles (Seeds)

Ion-exchanged water (5361.5 g) and L(+)-arginine (10.5 g, manufactured by Wako Pure Chemical Industries, Ltd.) were mixed and heated to 60° C. using a heater. After stirring at 150 rpm, an ethyl orthosilicate (628.0 g, manufactured by TAMA CHEMICALS CO., LTD.) was added thereto. 7 hours after the addition of ethyl orthosilicate, heating was stopped, and a seed slurry 2 was collected about 16 hours after heating was stopped. The seed slurry 2 obtained was transparent with no sediments.

### (ii) Preparation of Silica Dispersion

Ion-exchanged water (1368.5 g), an industrial alcohol preparation (Alcosol P-5, 1376.1 g, manufactured by AMAKASU CHEMICAL INDUSTRIES), and the seed slurry 2 (997.2 g) were mixed. Further, L(+)-arginine (1.33 g) and 25% ammonia water (81.0 g, manufactured by Taiseikakou Co., Ltd.) were added, and the solution temperature was raised to 55° C. using a heater. The solution was stirred at 750 rpm, and ethyl orthosilicate (675.9 g) and a 6.5 mass % aqueous solution containing ammonium borate octahydrate (11.3 g, manufactured by Wako Pure Chemical Industries, Ltd.) were added thereto at a time over 240 minutes, followed by concentration to about 15 mass % using an UF membrane module “Microza” type ACP-1013D, manufactured by Asahi Kasei Corporation (fraction molecular weight of the ultrafiltration membrane: 13,000) at a flow rate of a liquid fed of 3660 ml/minute and washing with water in an amount of 6 times the liquid volume, to thereby obtain a silica dispersion 2. The silica particles in the silica dispersion 2 obtained were amorphous.

Then, the same operation as in (iii) of Example 1 was performed to obtain silica dry powder 2, and the same operation was performed except that the temperature was raised to 1000° C. in (iv) of Example 1, to obtain a silica fired product 2. The silica fired product 2 obtained was amorphous. Further, the silica dry powder 2 and the silica fired product (fired powder) 2 were subjected to elemental analysis, and as a result, the boron decrement was 6.5%.

### Example 3

### (i) Preparation of Seed Particles (Seeds)

Seed particles were synthesized in the same manner as in Example 1.

### (ii) Preparation of Silica Dispersion

Ion-exchanged water (339.1 g), an industrial alcohol preparation (Alcosol P-5, 764.5 g, manufactured by AMAKASU CHEMICAL INDUSTRIES), and the seed slurry 1 (554 g) were mixed. Further, L(+)-arginine (0.7 g) and 25% ammonia water (216.5 g, manufactured by Taiseikakou Co., Ltd.) were added, and the solution temperature was raised to 50° C. using a heater. The solution was stirred at 180 rpm, and a mixed solution containing ethyl orthosilicate (375.5 g) and triethyl borate (14.5 g, manufactured by Tokyo Chemical Industry Co., Ltd.) was added thereto over 240 minutes, followed by concentration to about 15 mass % using an UF membrane module “Microza” type ACP-1013D, manufactured by Asahi Kasei Corporation (fraction molecular weight of the ultrafiltration membrane: 13,000) at a flow rate of a liquid fed of 3660 ml/minute, and washing with water in an amount of 6 times the liquid volume, to thereby obtain a silica dispersion 3. The silica particles in the silica dispersion 3 obtained were amorphous.

Then, the same operation as in (iii) of Example 1 was performed to obtain silica dry powder 3, and the same operation was performed except that the temperature was raised to 1000° C. in (iv) of Example 1, to obtain a silica fired product 3. The silica fired product obtained was amorphous. Further, the silica dry powder 3 and the silica fired product (fired powder) 3 were subjected to elemental analysis, and as a result, the boron decrement was 10%.

### Comparative Example 1

### (i) Preparation of Seed Particles (Seeds)

Seed particles were synthesized in the same manner as in Example 1.

### (ii) Preparation of Silica Dispersion

Ion-exchanged water (6392 g), an industrial alcohol preparation (Alcosol P-5, 7644 g, manufactured by AMAKASU CHEMICAL INDUSTRIES), and the seed slurry 1 (5540 g) were mixed. Further, L(+)-arginine (7 g) and 25% ammonia water (1664 g, manufactured by Taiseikakou Co., Ltd.) were added, and the solution temperature was raised to 40° C. using a heater. The solution was stirred at 120 rpm, and ethyl orthosilicate (3753 g) was added thereto over 240 minutes, followed by concentration to about 15 mass % using an UF membrane module “Microza” type ACP-1013D, manufactured by Asahi Kasei Corporation (fraction molecular weight of the ultrafiltration membrane: 13,000) at a flow rate of a liquid fed of 3660 ml/minute, and washing with water in an amount of 6 times the liquid volume, to thereby obtain a comparative silica dispersion 1. The silica particles in the comparative silica dispersion 1 obtained were amorphous.

Then, the same operation as in (iii) of Example 1 was performed to obtain comparative silica dry powder 1, and the same operation was performed except that the temperature was raised to 1000° C. in (iv) of Example 1, to obtain a comparative silica fired product 1. The comparative silica fired product 1 obtained was amorphous.

### Comparative Example 2

### (i) Preparation of Silica

Ethyl orthosilicate (119 g) and boron oxide (1.8 g, manufactured by Wako Pure Chemical Industries, Ltd.) were mixed with an industrial alcohol preparation (Alcosol P-5, 1184 g, manufactured by AMAKASU CHEMICAL INDUSTRIES) and dissolved therein. The solution was stirred at 300 rpm, and 25% ammonia water (10 g, manufactured by Taiseikakou Co., Ltd.) was added thereto, and the resultant was stirred for 12 hours, followed by concentration to about 15 mass % using an UF membrane module “Microza” type ACP-1013D, manufactured by Asahi Kasei Corporation (fraction molecular weight of the ultrafiltration membrane: 13,000) at a flow rate of a liquid fed of 3660 ml/minute, and washing with water in an amount of 6 times the liquid volume, to thereby obtain a comparative silica dispersion 2. The silica particles in the comparative silica dispersion 2 obtained were amorphous. When the comparative silica dispersion 2 was left stand, the solid content settled.

Then, the same operation as in (iii) of Example 1 was performed to obtain comparative silica dry powder 2, and the same operation was performed except that the temperature was raised to 1000° C. in (iv) of Example 1, to obtain a comparative silica fired product 2. The comparative silica fired product 2 obtained was amorphous. Further, the boron content of the comparative silica dry powder 2 was measured, and as a result, no boron was detected. It was considered from this that silica particles were not doped with boron due to the absence of the seed particles, and that boron was removed from the silica powder in the ultrafiltration process.

### Comparative Example 3

### (i) Preparation of Silica

Boric acid (9.5 g, manufactured by Wako Pure Chemical Industries, Ltd.) was dissolved in pure water (101 g), and 25% ammonia water (1058 g) was further added therein. The resulting mixture was designated as a solution A. Ethyl orthosilicate (99.5 g) was mixed with an industrial alcohol preparation (595 g), and the resulting mixture was designated as a solution B. The solution A was stirred at 400 rpm, and the solution B was added thereto, followed by stirring for 30 minutes. A mixed solution composed of 25% ammonia water (1512 g) and pure water (838 g) was added thereto, and the resultant was stirred for 18 hours, followed by concentration to about 15 mass % using an UF membrane module “Microza” type ACP-1013D, manufactured by Asahi Kasei Corporation (fraction molecular weight of the ultrafiltration membrane: 13,000) at a flow rate of a liquid fed of 3660 ml/minute, and washing with water in an amount of 6 times the liquid volume, to thereby obtain a comparative silica dispersion 3. The silica particles in the comparative silica dispersion 3 obtained were amorphous. When the comparative silica dispersion 3 was left stand, the solid content settled.

Then, the same operation as in (iii) of Example 1 was performed to obtain comparative silica dry powder 3, and the same operation was performed except that the temperature was raised to 1000° C. in (iv) of Example 1, to obtain a comparative silica fired product 3. The comparative silica fired product 3 obtained was amorphous. Further, the boron content of the comparative silica dry powder 3 was measured, and as a result, no boron was detected. It was considered from this that silica particles were not doped with boron due to the absence of the seed particles, and that boron was removed from the silica powder in the ultrafiltration process.

### Comparative Example 4

### (i) Preparation of Seed Particles (Seeds)

Seed particles were synthesized in the same manner as in Example 1.

### (ii) Preparation of Silica Dispersion

Ion-exchanged water (456.2 g), an industrial alcohol preparation (Alcosol P-5, 458.7 g, manufactured by AMAKASU CHEMICAL INDUSTRIES), and the seed slurry 1 (332.4 g) were mixed. Further, 25% ammonia water (81.0 g, manufactured by Taiseikakou Co., Ltd.) was added, and the solution temperature was raised to 45° C. using a heater. The solution was stirred at 490 rpm, and a mixed solution containing ethyl orthosilicate (225.3 g) and triethyl borate (23.4 g, manufactured by Tokyo Chemical Industry Co., Ltd.) was added thereto over 240 minutes. As a result, the mixture gelated. It was considered that since the amount of triethyl borate added was excessive, the reaction with ammonia in the system worked to cause agglomeration. Water was added to the gelated product, and gelatinous agglomerates were filtered out using a 20 μm filter. The filtrate was concentrated to about 15 mass % using an UF membrane module “Microza” type ACP-1013D, manufactured by Asahi Kasei Corporation (fraction molecular weight of the ultrafiltration membrane: 13,000) at a flow rate of a liquid fed of 3660 ml/minute, followed by washing with water in an amount of 6 times the liquid volume, to thereby obtain a comparative silica dispersion 4. The silica particles in the comparative silica dispersion 4 obtained were amorphous.

Then, the same operation as in (iii) of Example 1 was performed to obtain comparative silica dry powder 4, and the same operation was performed except that the temperature was raised to 1000° C. in (iv) of Example 1, to obtain a comparative silica fired product 4. The silica fired product obtained was amorphous. Further, the comparative silica dry powder 4 and the comparative silica fired product (fired powder) 4 were subjected to elemental analysis, and as a result, the boron decrement was 11%.

Table 1 shows the compositions of the raw materials and various physical properties of the silica dispersion obtained in each of Examples 1 to 3 and Comparative Examples 1 to 4.

TABLE 1

| | | | | Comparative | Comparative | Comparative | Comparative |
|---|---|---|---|---|---|---|---|
| | Example 1 | Example 2 | Example 3 | Example 1 | Example 2 | Example 3 | Example 4 |
| Boron concentration | 4.79 | 5.56 | 4.79 | 0 | 9.13 | 32.17 | 11.12 |
| (mol % B/silica solid content) | | | | | | | |
| Seed concentration | 13.3 | 13.3 | 13.3 | 13.3 | 0 | 0 | 13.3 |
| (mol % seed/silica solid content) | | | | | | | |
| NH₃ concentration | 31.8 | 31.8 | 152.7 | 117.5 | 26.3 | 7899.3 | 27.5 |
| (mol % NH₃/silica solid content) | | | | | | | |
| TEM average particle size (nm) | 29.9 | 28.8 | 35.5 | 28.3 | 40.3 | 821 | 125 |
| Coefficient of variation | 0.03 | 0.03 | 0.17 | 0.04 | 0.35 | 0.15 | 0.12 |
| (TEM diameter) | | | | | | | |
| Average circularity | 0.87 | 0.87 | 0.58 | 0.87 | 0.64 | 0.93 | 0.77 |
| Particle size distribution D50 (nm) | 31.3 | 28.6 | 32.3 | 31.5 | 41.3 | 1805 | 92.5 |
| Particle size distribution D100 (nm) | 60.4 | 70.0 | 80.4 | 61.5 | 1927 | 6526 | 1353 |
| Particle size distribution D90/D10 | 1.8 | 1.8 | 2.0 | 1.7 | 14.3 | 4.7 | 3.0 |
| Concentration of water dispersion (wt %) | 21 | 16 | 15 | 16 | 4 | 3 | 6 |
| Viscosity (mPa · s) | 2.82 | 5.06 | 5.12 | 5.00 | 2.50 | 2.80 | 2.75 |
| Sedimentation rate (%) | 0 | 0 | 1 | 0 | 4.1 | 8 | 7 |
| Boron content in dry powder after ultrafiltration | 3.2 | 4.3 | 2.9 | 0 | 0 | 0 | 4.7 |
| (proportion (mass %) in 100 | | | | | | | |
| mass % of a total of SiO₂ and B₂O₃) | | | | | | | |
| Boron decrement after firing (%) | 8.3 | 6.5 | 10 | — | — | — | 11 |

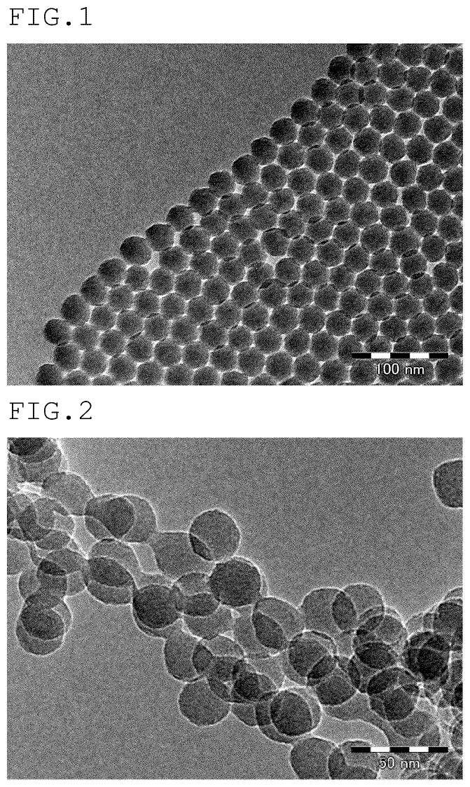

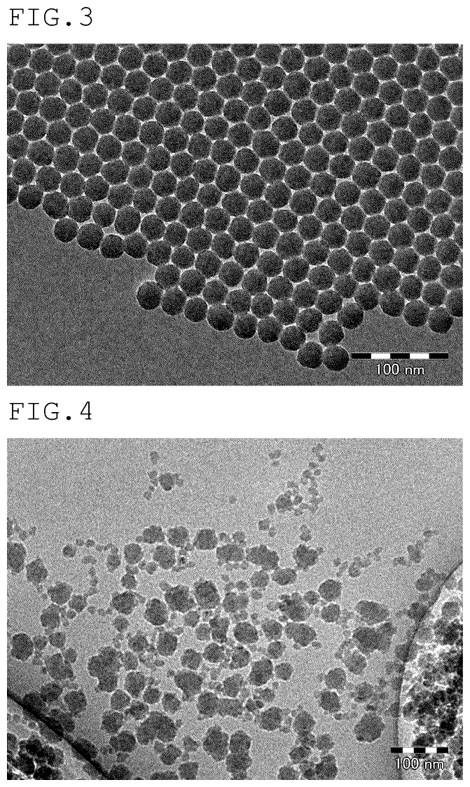

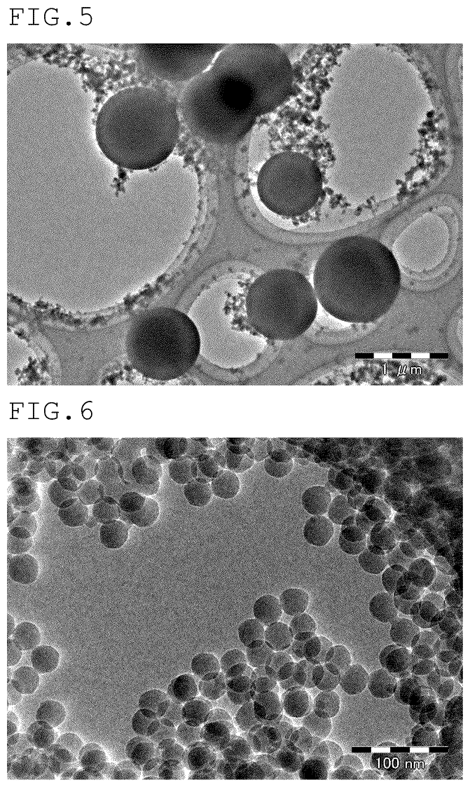

FIGS. 1 to 6 show TEM images of the silica dispersions obtained in Examples 1 to 3 and Comparative Examples 1 to 4.

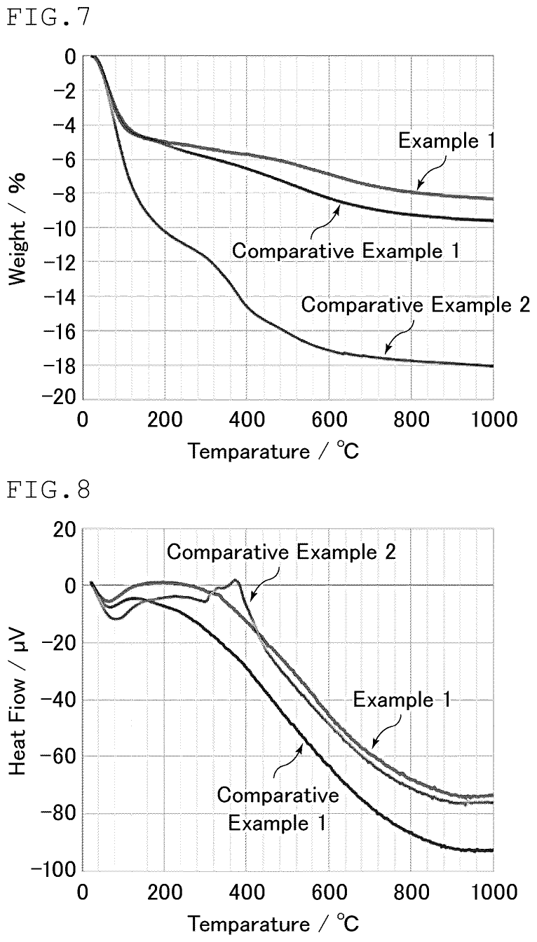

For the dry powders obtained in Example 1 and Comparative Examples 1 and 2, FIG. 7 shows the results of TG analysis for thermal weight loss analysis, and FIG. 8 shows the results of DTA analysis.

As a result of thermal weight loss analysis, no weight loss due to heating was confirmed for the silica dry powder of Example 1 of the present application. It is considered that the weight loss in Comparative Example 2 is due to the residual organic portion of the raw materials because of condensation and particle formation before hydrolysis was completed. This suggests that the hydrolysis was completed in Example 1, so that the silica particles with less volatile components were generated.

### MLCC HALT Test

The powders of Example 1 and Comparative Example 1 were used as MLCC materials and subjected to the HALT test. Each MLCC was produced by using BaTiO₃ as a base material and adding the powder obtained Example 1 or Comparative Example 1 in an amount of 0.1 wt % based on BaTiO₃. As a dopant, a Y—Dy—Mg—Mn—V-based dopant was used. The shape of the MLCC was 3225 size, and the interlayer thickness was 3 μm.

The MLCC produced was used for the HALT test. In the HALT test, the applied voltage was kept constant at 40 (V/μm), and the evaluation was made under the conditions of an acceleration temperature of 140° C. and an acceleration voltage of 128 V.

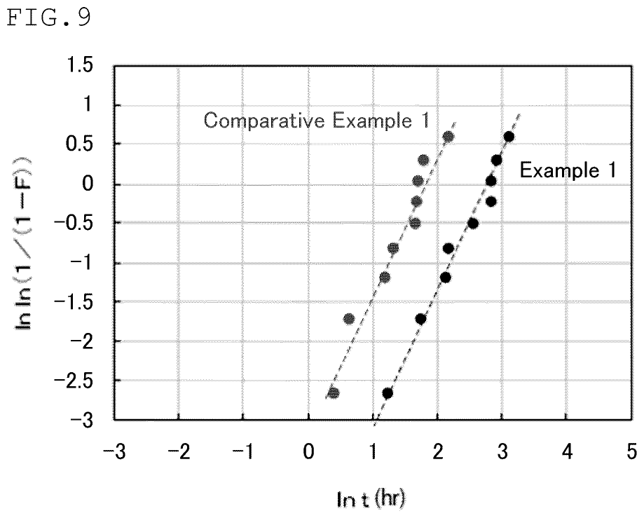

Table 2 and FIG. 9 show the results. As is clear from Table 2 and FIG. 9, the boron-containing silica of Example 1 had excellent in terms of the mean time to failure (MTTF).

TABLE 2

| | | | Comparative |
|---|---|---|---|
| | Name of sintering aid | Example 1 | Example 1 |
| MLCC | Amount of sintering aid added | 0.1 wt % based on BaTiO₃ | |
| design | (wt %) | | |
| | Dopant | Y—Dy—Mg—Mn—V | |
| | | system | |
| | Size | 3225 size | |
| | Interlayer thickness (μm) | 3 | |
| HALT | Applied voltage (V/μm) | 40 | 40 |
| test | Found interlayer thickness (μm) | 3.2 | 3.2 |
| | Acceleration voltage (V) | 128 | 128 |
| | Acceleration temperature (° C.) | 140 | 140 |
| | Mean time to failure MTTF (h) | 16.0 | 5.4 |

1. A boron-containing silica dispersion, comprising amorphous silica particles containing boron atoms and a dispersion medium,
the boron-containing amorphous silica particles having an average particle size of 10 to 100 nm, as determined from 40 particles selected at random in a transmission electron micrograph,
the boron-containing silica dispersion having a solids content of 5 to 30 mass %,
the boron-containing silica dispersion having a sedimentation rate of the particles of 4% or less, when the boron-containing silica dispersion is left standing for 1000 hours, and proportions of SiO₂ and B₂O₃ of 90.0 to 99.8 mass % and 0.2 to 10.0 mass %, respectively, in 100 mass % of a total of SiO₂ and B₂O₃, all in terms of oxide, when the boron-containing silica dispersion is subjected to ultrafiltration by the following method and dried:
<Ultrafiltration Method>
washing is performed by sequentially adding pure water in an amount of 6 times the volume of the boron-containing silica dispersion at a flow rate of a liquid fed of 3660 ml/minute using an ultrafiltration membrane with a fraction molecular weight of 13,000.

2. The boron-containing silica dispersion according to claim 1,
wherein the boron-containing amorphous silica particles have an average particle size D₅₀ of 10 to 100 nm in a particle size distribution thereof, as determined by the following method:
<Determination Method of Particle Size Distribution>
a volume-based average particle size is measured using a dynamic light scattering particle size distribution analyzer;
a slurry containing boron-containing amorphous silica particles is diluted with ion-exchanged water so that the particle concentration at the time of measurement is suitable for measurement (in the range of loading index=0.01 to 1);
measurement time is 60 seconds;
permeability of particle: permeable, refractive index of particle: 1.46, shape: perfect sphere, density (g/cm³): 1.00, solvent: water, refractive index: 1.333, viscosity at 30° C.: 0.797, and viscosity at 20° C.: 1.002; and
the 50th percentile of the particle size in the volume-based particle size distribution curve obtained is defined as the average particle size D₅₀ (nm).

3. The boron-containing silica dispersion according to claim 1,
wherein the boron-containing silica dispersion has a coefficient of variation of the particle size, standard deviation of particle size/average particle size, of 0.25 or less, as determined from 40 particles selected at random in a transmission electron micrograph.

4. The boron-containing silica dispersion according to claim 1,
wherein the boron-containing silica dispersion has D₉₀/D₁₀ of 4.0 or less and D₁₀₀ of 300 nm or less in the particle size distribution.

5. The boron-containing silica dispersion according to claim 1,
wherein the boron-containing amorphous silica particles have an average circularity of 0.65 or more, as determined by the following method:
<Determination Method of Average Circularity>
a file of a TEM image captured under a transmission electron microscope is read by an image analysis software, and an average circularity of 40 particles is determined by running an application for a particle analysis.

6. The boron-containing silica dispersion according to claim 1,
wherein a dried product of the boron-containing silica dispersion has a decrement in a boron content of 10 mass % or less, when the dried product is fired under the following conditions;
<Firing Conditions>
5 to 10 g of the dried product is filled into an alumina crucible, heated to 1000° C. to 1100° C. at 200° C./hour in the atmosphere, maintained as it is for 5 hours, and cooled to room temperature.

7. The boron-containing silica dispersion according to claim 1,
wherein the boron-containing silica dispersion has a viscosity of 15 mPa·s or less, as measured by the following method:
<Measurement Method of Viscosity>
the viscosity of the boron-containing silica dispersion is measured at a temperature of 25° C. using a vibration viscometer.

8. A method for producing the boron-containing silica dispersion according to claim 1, the method comprising
step (A) of obtaining seed particles containing silicon atoms,
step (B) of mixing the seed particles containing silicon atoms obtained in step (A), a silicon atom-containing compound different from the seed particles obtained in step (A), and a boron atom-containing compound.

9. The method for producing the boron-containing silica dispersion according to claim 8,
wherein the amount of the boron atom-containing compound used is 0.4 to 10 mol %, in terms of the number of boron atoms, based on 100 mol % of a total of silicon atoms in the seed particles containing silicon atoms and the silicon atom-containing compound different from the seed particles.

10. The method for producing the boron-containing silica dispersion according to claim 8,
wherein the amount of the seed particles containing silicon atoms used is 1 to 20 mol %, in terms of the number of silicon atoms, based on 100 mol % of a total of silicon atoms in the seed particles containing silicon atoms and the silicon atom-containing compound different from the seed particles.

11. The method for producing the boron-containing silica dispersion according to claim 8,
wherein in the mixing step (B), a basic catalyst is added in an amount of 10 to 50 mol % based on 100 mol % of a total of silicon atoms in the silicon atom-containing compound different from the seed particles and boron atoms in the boron atom-containing compound.
